(19) United States
(12) Patent Application Publication
(10) Pub. No.: US 2007/0181655 A1
(43) Pub. Date: Aug. 9, 2007

(54) WAVE SOLDER APPARATUS

(75) Inventors: Wen-Chi Chen, Kuei Shan Hsiang (TW); Jauwhei Hong, Kuei Shan Hsiang (TW)

Correspondence Address: Daniel R. McClure;Thomas, Kayden, Horstemeyer & Risley LLP, Suite 1750, 100 Galleria Parkway, Atlanta, GA, 30339, US

(73) Assignee: Quanta Computer Inc., Tao Yuan Shien (TW)

(21) Appl. No.: 11/380,229

(22) Filed: Apr. 26, 2006

(30) Foreign Application Priority Data
Feb. 3, 2006 (TW) 95103762

(51) Int. Cl. B23K 35/12; B23K 37/04

(52) U.S. Cl. 228/246; 228/49.1

(57) ABSTRACT

A wave solder apparatus. A conveyer carries a circuit board. A solder tank is disposed under the conveyer and includes a turbulent nozzle and a laminar nozzle separated therefrom. The turbulent nozzle includes a plurality of turbulent spouting holes. The ratio of the cross-sectional area of the turbulent spouting holes to that of the turbulent nozzle exceeds 0.377. A first heater is disposed under the conveyer and adjacent to the solder tank, heating the bottom surface of the circuit board. A second heater is disposed above the conveyer and opposes the first heater, heating the top surface of the circuit board.

### BACKGROUND OF THE INVENTION

1. Field of the Invention

The invention relates to a wave solder apparatus, and in particular to a wave solder apparatus for a lead-free wave solder process.

2. Description of the Related Art

In a conventional wave solder process, molten solder is filled in through holes of a printed circuit board (PCB), connecting pins, disposed in the through holes, of an electronic member to the PCB.

Generally, the molten solder in a solder tank is output to the through holes containing the pins of the electronic member from the bottom side of the PCB using a turbulent wave, filling in the through holes and covering the pins. The molten solder in the solder tank is then output to the bottom surface of the PCB using a laminar wave, removing redundant solder therefrom. Short circuit between the pins of the electronic member is thus prevented.

Moreover, compared to lead-free solder, leaded solder provides a low melting point and high surface tension. When output to the through holes of the PCB using the turbulent wave, the leaded solder is easily filled therein. The melting point of the lead-free solder, such as SAC (Sn/Ag/Cu) alloy, is often between 217° C. and 220° C. The melting point of the leaded solder is about 183° C. The surface tension of the leaded solder is higher than that of the lead-free solder. Accordingly, the leaded solder does not easily solidify on the bottom surface of the PCB and form solder bridges, which results in short circuit, between the pins of the electronic member. Namely, the molten leaded solder output to the bottom surface of the PCB using the laminar wave can easily remove the redundant leaded solder.

For environmental consideration, lead-free solder is commonly used. The lead-free solder with a high melting point (217° C.-220° C.), however, causes some problems in the wave solder process.

Referring to FIG. 1, a conventional wave solder device 1 comprises a conveyer 11, a solder tank 12, a first heater 13, and a second heater 14. The conveyer 11 carries printed circuit boards P. The solder tank 12 is disposed under the conveyer 11 and contains molten lead-free solder. Additionally, the solder tank 12 comprises a turbulent nozzle 12a and a laminar nozzle 12b. The first heater 13 and second heater 14 are disposed beside the solder tank 12 and respectively above and under the conveyer 11.

Moreover, as shown in FIG. 2, the turbulent nozzle 12a comprises a plurality of turbulent spouting holes 12a′ alternately arranged thereon, and the laminar nozzle 12b comprises a plurality of laminar spouting holes 12b′ linearly arranged thereon. A distance D1 between the centers of the turbulent nozzle 12a and laminar nozzle 12b is often 180 mm. The width of the turbulent nozzle 12a or a maximum horizontal distance D2 between the turbulent spouting holes 12a′ along the conveyer 11 is often 20 mm. Additionally, the turbulent spouting holes 12a′ are sparsely distributed on the turbulent nozzle 12a. Namely, the area of the turbulent spouting holes 12a′ in per unit area of the turbulent nozzle 12a is small (or the ratio of the total cross-sectional area of the turbulent spouting holes 12a′ to the cross-sectional area of the turbulent nozzle 12a is small).

As shown in FIG. 1, when transported in a direction A by the conveyer 11, printed circuit boards P are heated by the first heater 13 and second heater 14 in advance, having specific temperatures on the top and bottom surfaces thereof. When the printed circuit board P is transported to the top of the solder tank 12, the turbulent spouting holes 12a′ of the turbulent nozzle 12a upwardly output the molten lead-free solder in a direction B to through holes P1 (FIG. 3), containing pins E of electronic members, of the printed circuit board P. The laminar spouting holes 12b′ of the laminar nozzle 12b then output the molten lead-free solder in a direction C shown in FIG. 3 to the bottom surface of the printed circuit board P, removing redundant lead-free solder therefrom.

As shown in FIG. 3, having a high melting point, the lead-free solder S often solidifies before thoroughly filling in the through holes P1, thus not complying with regulations of through hole solder fill of the IPC standard, which asserts that solder must occupy at least 75% space of a through hole. Meanwhile, the redundant lead-free solder S solidifies on the lower portions of the pins E of the electronic members. The printed circuit board P is then transported to allow the through holes P1 thereof to be above the laminar nozzle 12b. As the distance D1 between the centers of the turbulent nozzle 12a and laminar nozzle 12b is large, the temperature of the bottom surface of the printed circuit board P is reduced when the printed circuit board P is transported to the top of the laminar nozzle 12b. Additionally, as the melting point of the lead-free solder is higher and the surface tension thereof is smaller, the molten lead-free solder output by the laminar spouting holes 12b′ of the laminar nozzle 12b cannot remove the redundant lead-free solder S, but further solidifies on the bottom surface of the printed circuit board P. Accordingly, short circuit between the pins E of the electronic members is generated.

Hence, there is a need for an improved wave solder apparatus for a lead-free wave solder process, thoroughly filling lead-free solder in through holes of a printed circuit board and effectively preventing formation of short circuit thereon.

### BRIEF SUMMARY OF THE INVENTION

A detailed description is given in the following embodiments with reference to the accompanying drawings.

An exemplary embodiment of the invention provides a wave solder apparatus comprising a conveyer, a solder tank, a first heater, and a second heater. The conveyer carries a circuit board. The solder tank is disposed under the conveyer and comprises a turbulent nozzle and a laminar nozzle separated therefrom. The turbulent nozzle comprises a plurality of turbulent spouting holes. The ratio of the cross-sectional area of the turbulent spouting holes to that of the turbulent nozzle exceeds 0.377. The first heater is disposed under the conveyer and adjacent to the solder tank, heating the bottom surface of the circuit board. The second heater is disposed above the conveyer and opposes the first heater, heating the top surface of the circuit board.

A maximum horizontal distance between the turbulent spouting holes along the conveyer is between 20 mm and 80 mm.

A distance between the centers of the turbulent nozzle and laminar nozzle along the conveyer is between 30 mm and 140 mm.

### BRIEF DESCRIPTION OF THE DRAWINGS

The invention can be more fully understood by reading the subsequent detailed description and examples with references made to the accompanying drawings, wherein:

FIG. 1 is a schematic side view of a conventional wave solder device;

FIG. 2 is a partial top view of a turbulent nozzle and a laminar nozzle of the wave solder device of FIG. 1;

FIG. 3 is a schematic view showing soldering, produced by the wave solder device of FIG. 1, between a printed circuit board and pins of electronic members;

FIG. 4 is a schematic side view of a wave solder device of the invention;

FIG. 5 is a partial top view of a turbulent nozzle and a laminar nozzle of the wave solder device of the invention; and

FIG. 6 is a schematic view showing soldering, produced by the wave solder apparatus of the invention, between a circuit board and pins of an electronic member.

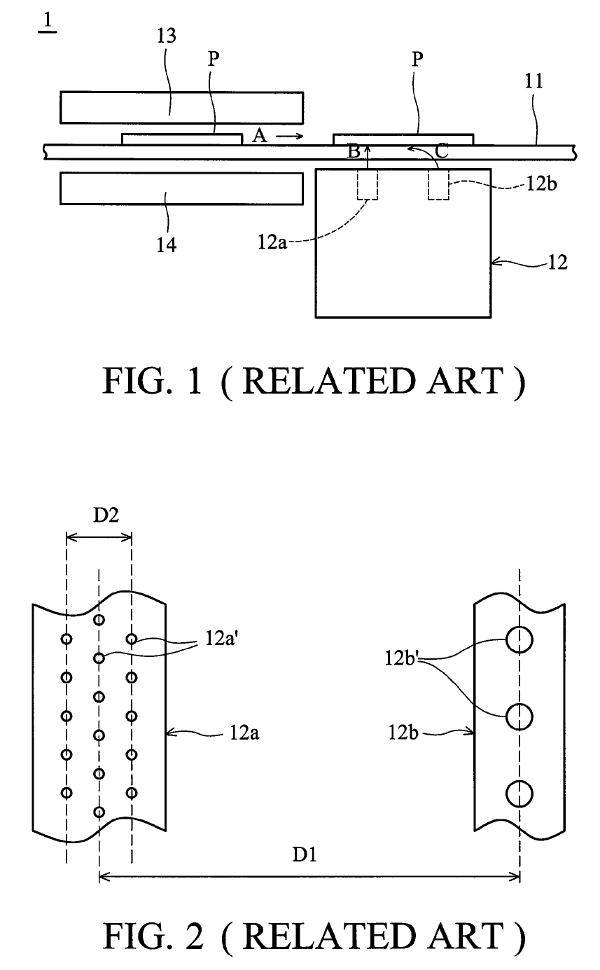

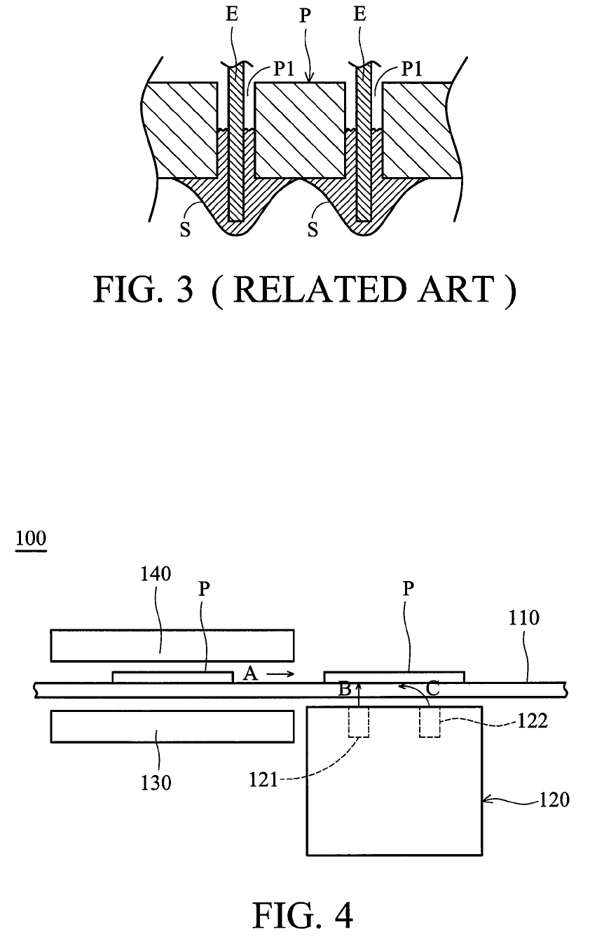

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Referring to FIG. 4, a wave solder apparatus 100 comprises a conveyer 110, a solder tank 120, a first heater 130, and a second heater 140.

The conveyer 110 carries circuit boards P. As shown in FIG. 6, each circuit board P has a plurality of through holes P1, in which pins E of an electronic member respectively fit.

As shown in FIG. 4, the solder tank 120 is disposed under the conveyer 110 and contains molten lead-free solder. Additionally, the solder tank 120 comprises a turbulent nozzle 121 and a laminar nozzle 122 separated therefrom.

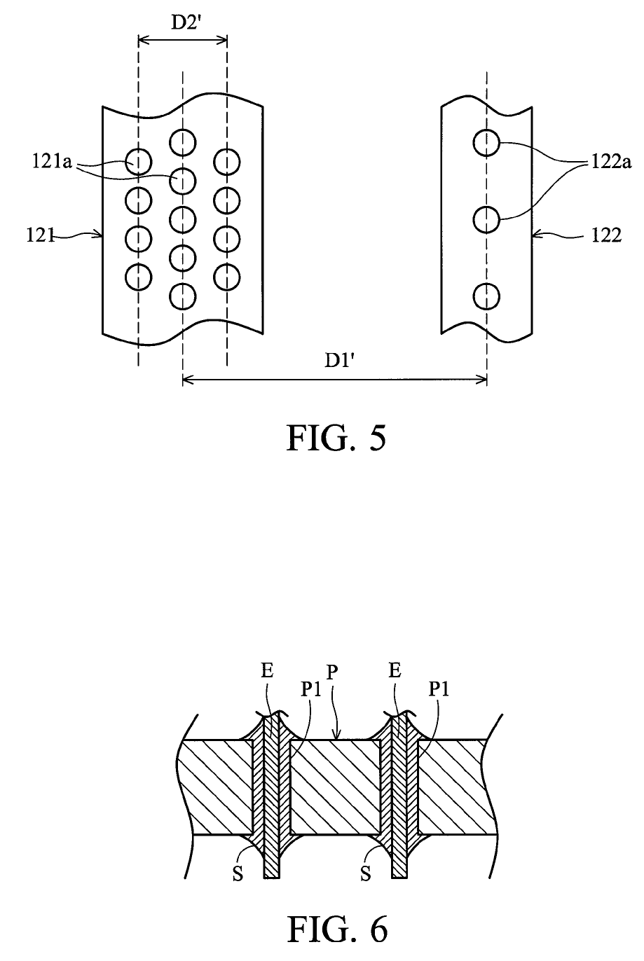

As shown in FIG. 5, a smaller distance D1′ exists between the centers of the turbulent nozzle 121 and laminar nozzle 122 along the conveyer 110. The distance D1′, in this embodiment, is between 30 mm and 140 mm. The turbulent nozzle 121 comprises a plurality of turbulent spouting holes 121a alternately arranged thereon. The laminar nozzle 122 comprises a plurality of laminar spouting holes 122a linearly arranged thereon. The ratio of the cross-sectional area of the turbulent spouting holes 121a to that of the turbulent nozzle 121 exceeds 0.377. A maximum horizontal distance D2′ between the turbulent spouting holes 121 a along the conveyer 110 is between 20 mm and 80 mm.

As shown in FIG. 4, the first heater 130 is disposed under the conveyer 110 and adjacent to the solder tank 120, heating the bottom surface of the circuit board P. The second heater 140 is disposed above the conveyer 110 and opposes the first heater 130, heating the top surface of the circuit board P.

When transported in a direction A shown in FIG. 4 by the conveyer 110, the circuit board P is heated by the first heater 130 and second heater 140 in advance, having specific temperatures on the top and bottom surfaces thereof.

Accordingly, the molten lead-free solder in the solder tank 120 is upwardly output to the through holes P1 (FIG. 6) containing the pins E (FIG. 6) of the electronic member in a direction B shown in FIG. 4 by the turbulent nozzle 121. As the maximum horizontal distance D2′ between the turbulent spouting holes 121a along the conveyer 110 is large and the ratio of the cross-sectional area of the turbulent spouting holes 121a to that of the turbulent nozzle 121 is promoted (exceeds 0.377), time spent upwardly filling the lead-free solder in the through holes P1 and quantity thereof are increased. Accordingly, the molten lead-free solder does not solidify due to reduced temperature, thus upwardly and thoroughly filling in the through holes P1, as shown by lead-free solder S of FIG. 6.

In another aspect, the molten lead-free solder in the solder tank 120 is output to the bottom surface of the circuit board P, in a direction C shown in FIG. 4, by the laminar nozzle 122 (laminar spouting holes 122a). As the distance D1′ between the centers of the turbulent nozzle 121 and laminar nozzle 122 along the conveyer 110 is small (between 30 mm and 140 mm), the temperature of the bottom surface of the circuit board P is not rapidly or significantly reduced. Accordingly, the molten lead-free solder output to the bottom surface of the circuit board P does not easily solidify, thus removing redundant lead-free solder from the bottom surface thereof. Short circuit between the pins E of the electronic member is thus prevented.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A wave solder apparatus, comprising:
a conveyer carrying a circuit board;
a solder tank disposed under the conveyer and comprising a turbulent nozzle and a laminar nozzle separated therefrom, wherein the turbulent nozzle comprises a plurality of turbulent spouting holes, and the ratio of the cross-sectional area of the turbulent spouting holes to that of the turbulent nozzle exceeds 0.377;
a first heater disposed under the conveyer and adjacent to the solder tank, heating the bottom surface of the circuit board; and
a second heater disposed above the conveyer and opposing the first heater, heating the top surface of the circuit board.

2. The wave solder apparatus as claimed in claim 1, wherein a maximum horizontal distance between the turbulent spouting holes along the conveyer is between 20 mm and 80 mm.

3. The wave solder apparatus as claimed in claim 1, wherein a distance between the centers of the turbulent nozzle and laminar nozzle along the conveyer is between 30 mm and 140 mm.
